(19) United States
(12) Patent Application Publication
(10) Pub. No.: US 2005/0219416 A1
(43) Pub. Date: Oct. 6, 2005

(54) Methods and application for capturing image content conforming to electronic device format

(76) Inventor: Christopher C. Gielow, Chicago, IL (US)

Correspondence Address: MOTOROLA INC, 600 NORTH US HIGHWAY 45, ROOM AS437, LIBERTYVILLE, IL, 60048-5343, US

(21) Appl. No.: 10/814,721

(22) Filed: Mar. 31, 2004

(51) Int. Cl. H04N 5/46; H04N 11/20

(52) U.S. Cl. 348/556; 348/445

(57) ABSTRACT

A method for capturing an image in a graphical user interface computing environment including positioning (220) an image viewfinder about an image displayed in the graphical user interface computing environment, an aspect ratio of the image viewfinder corresponding to an aspect ratio of a device to which image information obtained from the graphical interface computing environment will be sent, capturing (240) the image having an aspect ratio corresponding to the aspect ratio of the recipient device. In some embodiments, a sliding tile puzzle game is created from image tiles formed from the captured image. The captured image is transmitted (260) to the recipient device.

### FIELD OF THE DISCLOSURE

The present disclosure relates generally to image capture applications, and more particularly to image capture applications in graphical user interface computing environments, for example, on windows based personal computers, for capturing and tailoring image information for use in a particular electronics device, for example, in a wireless communications device, and methods.

### BACKGROUND OF THE DISCLOSURE

Recent advancements in display technology and market factors have resulted in the widespread emergence of an array of relatively lowcost handheld portable electronics devices, for example, cellular telephones and personal digital assistants, among other devices, including relatively high resolution color displays, most commonly in the form of liquid crystal displays. The displays on these devices generally have however different aspect ratios, resolutions, color depths, and other particular characteristics.

Presently, there is no quick and easy way for users to import images onto wireless handsets and other electronics devices for personal use and for sharing. These images usually originate from a variety of sources, each potentially having its own application, file-types, size, aspect ratio, color depth, etc., which adds to the complexity of the task.

Although PC software, for example, “Mobile PhoneTools”, exists for importing files onto wireless communications handsets, the complexity of the task, which includes navigating a file system and manipulating images to match the size, resolution and type of the target device is unappealing to the casual users constituting the bulk of the market.

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

FIG. 1 illustrates an exemplary image-capture application running in a graphical user interface computing environment.

FIG. 2 is an exemplary process flow diagram.

FIG. 3 illustrates an exemplary image capture utility viewfinder-invoking hot key.

FIG. 4 illustrates the transfer of captured image information to a recipient device during synchronization.

FIG. 5 illustrates an exemplary puzzle-generating feature or application.

FIG. 6 illustrates a puzzle game on a wireless communications device.

### DETAILED DESCRIPTION

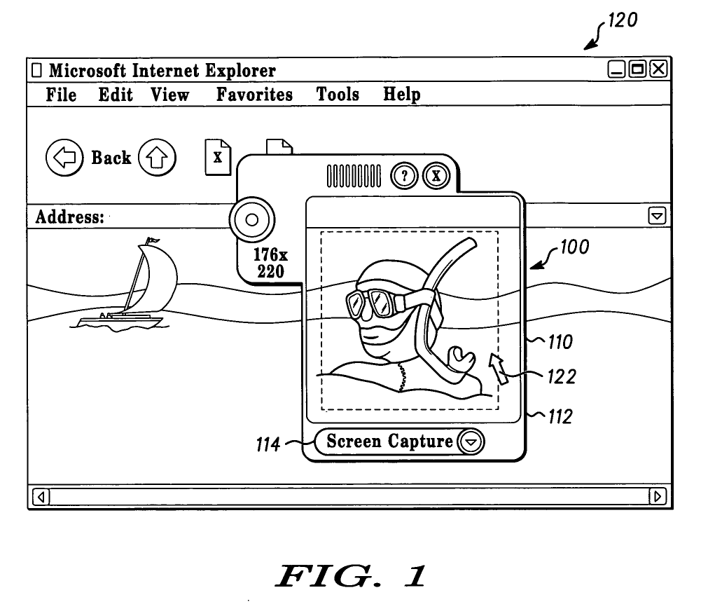

In FIG. 1, an exemplary image-capture application 100 is illustrated running in a computing environment 120 that displays image information, for example, a graphical user interface (GUI) environment. The exemplary GUI in FIG. 1 is a MICROSOFT WINDOWS environments, though in other embodiments it could be any other environment, for example, the APPLE MACINTOSH operating system, among others, some of which are known and others to be developed.

The exemplary image capture application 100 comprises generally an image viewfinder 110 that may be dragged or otherwise positioned about the GUI environment by the user, for example, by movement of a cursor 120 or by some other user operable controller. The image viewfinder 110 is generally positioned over an image displayed in the GUI environment. In FIG. 1, for example, the image viewfinder 10 is positioned over an image displayed in an MS INTERNET EXPLORER application, though the viewfinder 110 may be positioned about the exemplary WINDOWS desktop and/or application running thereon. In the exemplary WINDOWS environment and similar environments, the image viewfinder 110 is movable over the applications running on the WINDOWS desktop. More generally, the viewfinder 110 may be positioned over images or graphics information displayed in or by any application in the GUI environment. Upon locating an image or graphical information desired, the image or information is subsequently captured for transfer to a recipient device as discussed more fully below.

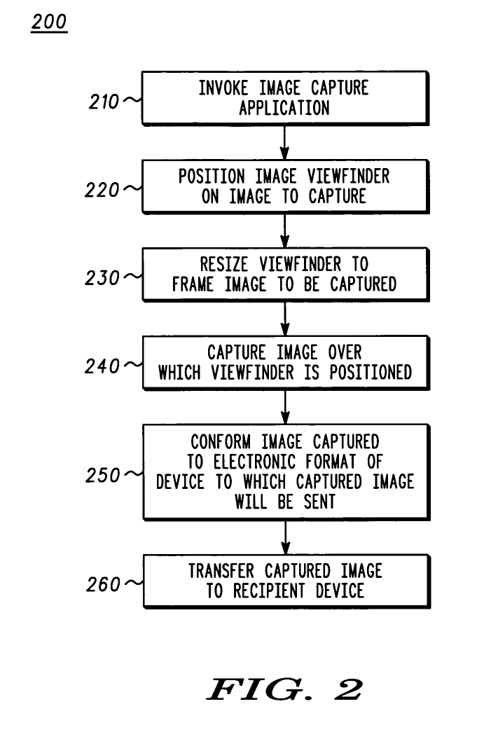

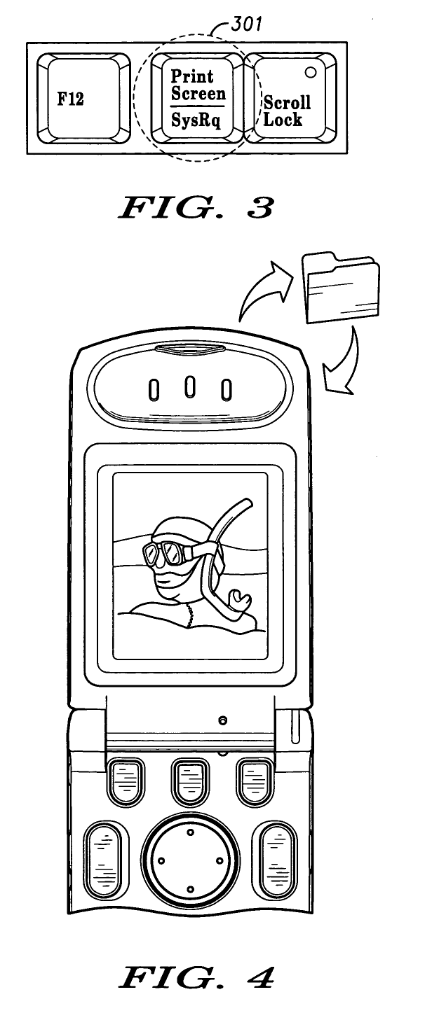

The viewfinder 110 of the image capture application is invoked by a viewfinder-invoking feature accessible via the graphical user interface (GUI) computing environment on which the image capture application resides or by a hard or soft hotkey. In the process flow diagram 200 of FIG. 2, the image capture application is invoked at block 210, resulting in the display of the of the image viewfinder. In the exemplary embodiment, the image capture application may be launched by any known mode including, among others, selection of a corresponding application icon located on the desktop or in WINDOWS START menu. FIG. 3 illustrates an exemplary hotkey, “PrintScrn”, 301 that may be used for invoking the image capture application, which could run as a dormant application or utility. The image capture invoking feature or mechanism is preferable selected to minimize the effort required to launch the image capture application. In FIG. 2, at block 220, upon invoking the image capture application and displaying the image viewfinder, the viewfinder may be moved about the display and positioned over an image to be captured.

According to one aspect of the disclosure, the image viewfinder 110 has an aspect ratio of a display on a corresponding device to which an image captured on the GUI computing environment will be transmitted. Exemplary recipient devices include wireless communications devices and other electronics devices having displays with a particular aspect ratio. Mobile wireless communications, personal digital assistants and other electronics device typically have display aspect ratios of 4/3 or 16/9. These exemplary aspect ratios are not intended to limit the scope of the disclosure, but instead illustrate the variety of display aspect ratios in common usage.

In some embodiments, the image capture utility includes an aspect ratio selection feature, for example, a pull-down menu, allowing a user to select one of several different aspect ratios. The different aspect ratio selections could be specified in terms of aspect ratios, or in terms of the different devices to which they correspond, thus relieving the user of possessing specific knowledge of the aspect ratio for a particular device. In other embodiments, the image capture utility has only a single fixed aspect ratio.

In some embodiments, the dimensions of the viewfinder window may be increased or decreased, for example, to accommodate or frame different size images in the host application. The viewfinder may be re-dimensioned by stretching one of the sides of the viewfinder frame portion 112, as is known generally in window applications and environments. According to a related aspect of the disclosure, the aspect ratio remains constant when the viewfinder dimensions are changed, thereby allowing users to frame a particular image while maintaining the aspect ratio for particular recipient device. In FIG. 2, at block 230, the viewfinder is re-dimensioned, if necessary to accommodate the image displayed.

In FIG. 2, at block 240, the image over which the image viewfinder is positioned is captured. In some embodiment, the image capture process includes storage of the image captured in memory, for example, in random access memory. Also, in some embodiments, the captured image is provided a name. In FIG. 1, the exemplary viewfinder 110 includes an image capture button 114, which may be selected, for example, by positioning the cursor or pointer 122 and clicking on it. In other embodiments, the image capture function may be performed by some other mechanism. Thus the aspect ration of the captured image will conform to the aspect ratio of the recipient device.

In FIG. 2, at block 250, the image captured is further conformed to an electronic format of a recipient device, for example, for the device to which the aspect ratio of the image viewfinder corresponds. In one embodiment, the captured image is automatically conformed to the electronic format of the recipient device upon capturing the image without further input from the user. Examples of image characteristics that may be automatically conformed to the format of the recipient device are discussed further below. In other embodiments, additional user input is required to conform the image.

In one embodiment, the format of the image is captured is conform to a format of the recipient device. Some common image formats include JPEG, GIF and PNG. Other exemplary image formats include BMP, SVG, SWF, SMIL, MPEG, MOV, AVI, among others. The re-formatting of the image may result in a change in the file name, for example, a change in the file extension. Thus the format of the image captured may also be made to conform to that of the recipient device. In some embodiments, the image capture application enables the user to select one of several formats, for example, from a pull-down window. In other embodiments, the image capture application formats captured images to a single format corresponding to the format of the recipient device.

In another embodiment, the color depth of the captured image is conformed to a color depth the recipient device. Color depth is generally the distinct number of colors that may be presented or displayed by the recipient device. In other embodiments, the image captured may be resized to conform to a display size of recipient device. Exemplary wireless cellular communications device display sizes include 96×64, 128×96, 128×160 and 176×220 pixels. Some or all of these and other characteristics of the captured image may be conformed to the recipient device.

In FIG. 2, at block 260, the captured image is transmitted, either wirelessly or by wire-line, to the recipient device after any conforming by the image-capture application. Thus, for example, the transferred image may have any one or more of the same aspect ratio, color depth, size, format etc. of the recipient device, thus enabling the recipient device to display the image with little or no subsequent conforming by the recipient device. In some embodiments, the captured image is transferred to the recipient device in a message format, for example, as an EMS, SMS, MMS or some other message format. Alternatively, the message could be an e-mail message.

In another embodiment the captured image may be transferred to the recipient device during synchronization with the GUI computing environment. In FIG. 4, one or more captured images are transferred to the recipient device in a folder. Upon transferring the images onto the recipient device, the images may be viewed or otherwise displayed, for example, as wallpaper. The images may also be communicated to other devices, for example, via messages.

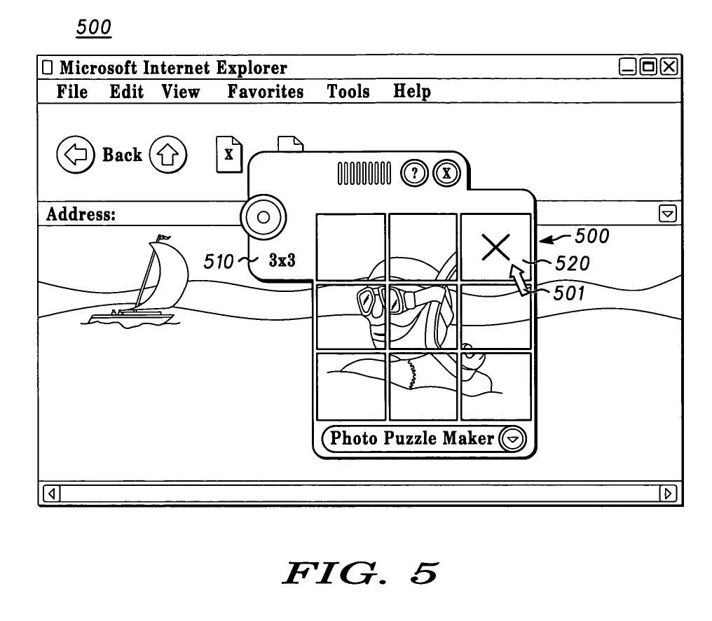

In the exemplary embodiment illustrated in FIG. 5, the application 500 running on the GUI computing environment includes a puzzle-generating feature. Selection of the puzzle maker may be made, for example, by selecting a radio button on the image viewfinder. In other embodiments, however, the game-generating feature is a separate application, which may be invoked by means known to those of ordinary skill in the art.

In the exemplary embodiment illustrated in FIG. 5, the puzzle making feature or application is characterized by the formation or division of the captured image over which the viewfinder is positioned into an n×m matrix of pixels or image tiles. In FIG. 5, the image is divided into a 3×3 matrix, though in other embodiments the matrix may be other dimensions. Also, the matrix dimensions may not be even, for example, the matrix of image tiles could be a 4×3 matrix. In some embodiments, the user may select the matrix size. More image tiles make the puzzle more complex, and less make it less complex, as discussed further below. In embodiments, where the user selects the matrix size, the selection may be made from a pull-down menu. In FIG. 5, the matrix size is indicated on the viewfinder at 510. The user must select one of the image tiles for removal, for example, using the cursor 501. In FIG. 5, file 520 has been selected for removal. Generally, the file selected for removal will be one that contains less significant image information relative to the other tiles, though the user is free to select any tile for removal. Upon selecting an image tile for removal, the application generates the puzzle game, which is transmitted to the recipient device as discussed above in connection with the captured image. Also, in some embodiments, the image of the puzzle game is conformed to the format of the recipient device, as discussed above.

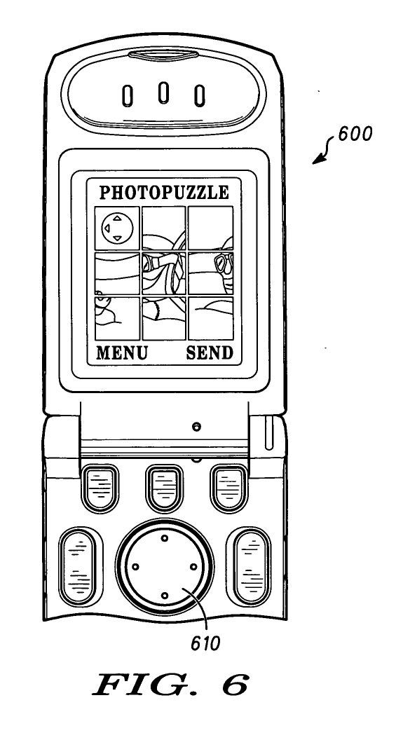

In FIG. 6, the puzzle game is displayed on an exemplary electronic device 600. In one embodiment, the puzzle game may be run as an application on the host device. The puzzle game includes an image tile scrambling mechanism to disorder the image displayed as wallpaper. In one embodiment, the scrambling mechanism may be a button on the application. In another embodiment, the scrambling mechanism may be by manually moving the tiles about the display, for example, by using the directional input 610 in FIG. 6. The puzzle game may also be transmitted to other devices.

While the present disclosure and what are presently considered to be the best modes thereof have been described in a manner establishing possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

1. A method for capturing an image in a graphical user interface computing environment, the method comprising:
positioning an image viewfinder about an image displayed in the graphical user interface computing environment;
capturing the image about which the viewfinder is positioned, the captured image having an aspect ratio corresponding to the aspect ratio of the recipient device;
automatically conforming at least one characteristic of the image captured to an electronic data format of a recipient device using the image-capture application.

2. The method of claim 1,
automatically conforming the at least one characteristic of the image captured to the electronic data format of the recipient device includes providing the captured image with an aspect ratio that is the same as an aspect ratio of the recipient device.

3. The method of claim 1, automatically conforming the at least one characteristic of the image captured to the electronic data format of the recipient device includes resizing the image captured.

4. The method of claim 1, automatically conforming the at least one characteristic of the image captured to the electronic data format of the recipient device includes changing a color depth of the image captured.

5. The method of claim 1, automatically conforming the at least one characteristic of the image captured to the electronic data format of the recipient device includes changing a format of the image captured to a format of the recipient device.

6. The method of claim 1, sending the captured image, having the aspect ratio of the recipient device, to the recipient device.

7. The method of claim 6, sending the captured image, having the aspect ratio of the recipient device, to the recipient device when synchronizing information of the recipient device with information of the graphical user interface computing environment.

8. The method of claim 1, dividing the image about which the viewfinder is positioned into n×m image tiles, selecting one of the n×m image tiles for removal.

9. The method of claim 8,
creating a sliding tile puzzle game in which positions of the n×m image tiles remaining after removing the image tile selected must be unscrambled.

10. The method of claim 1, invoking the image viewfinder having the aspect ratio corresponding to the aspect ratio of the device to which image information obtained from the graphical interface computing environment will be sent upon starting an image capture application in the graphical user interface computing environment.

11. A method for operating an image-capture application in a graphical user interface computing environment, the method comprising:
positioning a viewfinder of the image-capture application about an image displayed in the graphical user interface computing environment,
an aspect ratio of the viewfinder corresponding to an aspect ratio of a recipient device of image information captured in the graphical user interface computing environment;
capturing the image about which the viewfinder is positioned using the image-capture application, the captured image having an aspect ratio corresponding to the aspect ratio of the recipient device.

12. The method of claim 11,
sending the captured image, having the aspect ratio of the recipient device, to the recipient device using the image-capture application.

13. The method of claim 12, sending the captured image, having the aspect ratio of the recipient device, to the recipient device in an electronic message invoked by the image-capture application.

14. The method of claim 12, sending the captured image, having the aspect ratio of the recipient device, to the recipient device when synchronizing information of the recipient device with information of the graphical user interface computing environment.

15. The method of claim 11,
creating a sliding tile puzzle game from image tiles formed from the captured image,
sending the captured image, having the aspect ratio of the handheld electronics device, to the recipient device as the image tiles constituting the sliding tile puzzle game.

16. The method of claim 11,
conforming at least one characteristic of the image captured to an electronic format of the recipient device using the image-capture application, and
sending the captured image to the recipient device after conforming the image.

17. The method of claim 16, conforming the image captured includes at least one of resizing the image captured, changing a color depth of the image captured, and changing a format of the image captured.

18. The method of claim 11, displaying the image viewfinder having the aspect ratio corresponding to the aspect ratio of the recipient device of image information captured in the graphical user interface computing environment upon starting an image capture application in the graphical user interface computing environment.

19. The method of claim 11, re-dimensioning the viewfinder while maintaining the aspect ratio of the viewfinder in correspondence with the aspect ratio of the recipient device of image information captured in the graphical user interface computing environment.

20. An image-capture application for operation in a computing environment that displays image information, the image-capture application comprising:
an image viewfinder having an aspect ratio of a recipient device, the image view finder navigable by a user about a display in the computing environment;
an image-capture feature that captures image information within the image viewfinder;
an image conformance feature for automatically conforming characteristics of the image captured to an electronic format of the recipient device.

21. The image-capture application of claim 20,
the image conformance feature for at least one of resizing the image captured, changing a color depth of the image captured, and changing a format of the image captured.

22. The image-capture application of claim 20, game generator for generating a sliding image tile puzzle from image tiles formed from portions of the image captured.

23. The image-capture application of claim 20, an image transfer feature for sending an electronic message including the captured image, having the aspect ratio of the recipient device, to the recipient device.

24. The image-capture application of claim 20, an image transfer feature for sending the captured image, having the aspect ratio of the recipient device, to the recipient device during synchronization of the recipient device with information of the computing environment.

25. The image-capture application of claim 20, a viewfinder-invoking feature for displaying the image viewfinder having the aspect ratio of a recipient device invoked upon starting the image-capture application.

26. A method in a wireless communication device, the method comprising:
displaying on the wireless communications device an image divided into a n×m matrix of image tiles, less one image tile;
providing an image tile scrambling mechanism to disorder the image displayed as wallpaper;
providing a mechanism for moving the image tiles to re-order the scrambled image.
